(19) United States
(12) Patent Application Publication
(10) Pub. No.: US 2003/0235458 A1
(43) Pub. Date: Dec. 25, 2003

(54) One hand open structure of file folder clips

(75) Inventor: Chun-Sheng Huang, Taipei (TW)

Correspondence Address: BACON & THOMAS, PLLC, 625 SLATERS LANE, FOURTH FLOOR, ALEXANDRIA, VA, 22314

(73) Assignee: O K Buying Co., Ltd., Taipei (TW)

(21) Appl. No.: 10/178,022

(22) Filed: Jun. 24, 2002

(51) Int. Cl. B42F 13/00

(52) U.S. Cl. 402/26

(57) ABSTRACT

One hand open file folder clips are composed mainly by straight type long board fixture, right hand buckle plate and left hand buckle plate. The right hand buckle plate is hinged together with a T type holding clip and a 70% hook holder and a concave place to fit the holding finger. The left hand buckle plate is hinged together with 30% hook holder and a stop with inverse curb piece of board. The long type board fixture, right and left hand buckle plate to be hinged together with a half pin and by a spring. Finally, let the document paper to be fixed by holding up on the 70% hook holder while open up by one hand's fingers. Besides, let the opposite composition of file folder clip fixture connect to the original one to form a four holes file holder clips.

### BACKGROUND OF THE INVENTION

One hand open file folder clips board are composed mainly by straight type long board fixture, right hand buckle plate and left hand buckle plate. The right hand buckle plate is hinged together with T type holding clip, with a 70% hook holder and a concave place to fit the holding finger. While the left hand buckle plate is hinged together with a 30% hook holder and a stop with inverse curb piece of boards. Let the long type board fixture, the right hand and the left hand buckle plate to be hinged together by a half pin and a spring. And let the document paper to be fixed by holding up on the 70% hook holder while open up by one hand. In addition, let the opposite composition fixture connects to the original one to form a four hole file folder clips.

1. Field of the Invention

This project relates to the one hand open file folder structure. Especially, it is the kind that is easy to be opened by one hand, and easy to fix or hold paper documents up while it is light and easy to transmit paper document to file folder.

Ordinary, a common traditional file folder structure is set up with multiple knocking pins. Let the knocking pins to be put up to a holding pad. When in use, let the knocking pin striking through the paper document hole to collect the superimposed pad pile up or fold up paper documents. And when it is to pick up paper documents, to hold down to press the paper by both hands are needed. Either to let the holding pole pile up, or to let both hands to hold open the knocking poles to select the papers require strong force. Due to the file folder is not convenient to be used by most people, it is even more difficult to be used by those weak lady workers. Further more, to let the holding pole spring up is a more difficult job.

2. Prior Art Documents

The R.O.C. Chinese Gazette 2001-5-21 published No.437594 ┌Assembled Document File Folder Structure Improvement┘ is composed of two opposite coupled and one midway coupling hinged board. To go with rolling spine seat and spine to form a combined structure of file folder and let two side file folder plates to be independently form with middle hinged coupling plate together. Grouping with plate sides and coupling nods independently extrudes arrangements of bearing seat and seat worm together with incorporate and coessential node stem. This structure is totally different from the application. The R.O.C. Chinese Gazette 1998-12-21 published No. 348631 ┌File Folder Structure Improvement┘ is to set up the installing seat, and setting up in the installing seat the assuming nip clamp. The seating clamp is to form with extruding pivot in the middle part to bend like Π type holding seat. There is a spring form in between the holding seat and touching plate. In addition, there is the bearing seat and the bearing hole to be formed in between. This one is also totally different from the application. The R.O.C. Chinese Gazette of 1999-1-1 published No.349485 ┌The File Folder Structure Improvement┘ is to set up by the sticking plate, fixing plate, pressure holding plate and the connecting plate. The sticking plate is for gluing something together, fixing plate is to have gluing stuff. The two sides that hold two connecting rods together is close. Pressure holding plate is to hold two connect rods. And the connecting plate is to form close loop winding together. The overall structure is totally different from this application. Not to be mentioned in the same way as it used to be.

### THE INVENTION GOAL

This invention has its main purpose. It is to provide the construction of the one hand open file holder structure. It includes long type board, right hand buckle plate, and left hand buckle plate. The horizontal part that is next to the right hand buckle plate includes a T type grip plate, and the holding plate on the other side. And the left hand holding plate includes flat cross inverse hook and holding plate that holds paper on the other side. It is to form with the two applying paper documents together to be a file folder. In addition, the right hand side plate constructs a kind of two way concave holes to be controlled by two fingers in one hand. To let the applying fingers' concave holes to open the right and left hand side buckle plates. In order to fill up the paper documents or to pick up the paper document's finction, by the buckle plate to buckle up the buckle hole. This is the function to collect and to fill up the paper document in the file holder.

The other purpose of this invention is to utilize the two totally same file folder clips to be set up by one single paper holder. Opposite to the original long type structure is to set the totally same structure but to concave in the reverse side way. And to form the four holes paper clip board holder. When the paper document fully holds to the four holes to prevent the documents from falling.

### SEVERAL VIEWS OF THE DRAWING

This application has its main novel feature and inventiveness. A more clearly explanation is indicated to match the following figures.

FIG. 1 Indicates the long type board of this invention;

FIG. 2 Indicates the right hand buckle plate;

FIG. 3 Indicates the left hand buckle plate;

FIG. 4 Indicates the open up of this invention;

FIG. 5 Indicates the close down of this invention;

FIG. 6 Indicates the two holes file folder;

FIG. 7 Indicates the four holes file folder;

Parts Number

| | |
|---|---|
| 1. Long type board fixture | 2. Right hand buckle plate |
| 3. Left hand buckle plate | 4. Convex shoulder plate |
| 5. Concave notch plate | 6. Half-round convex flange |
| 7. Half-round concave | 8. 70% hook holder |
| 9. Concave flute | 10. Point extruder convex fillet |
| 11. T type convex | 12. Inverse hook hanger |
| 13. 30% hook holder | 14. Concave flute |
| 15. Spring | |

### DETAILED DESCRIPTION OF THE INVENTION

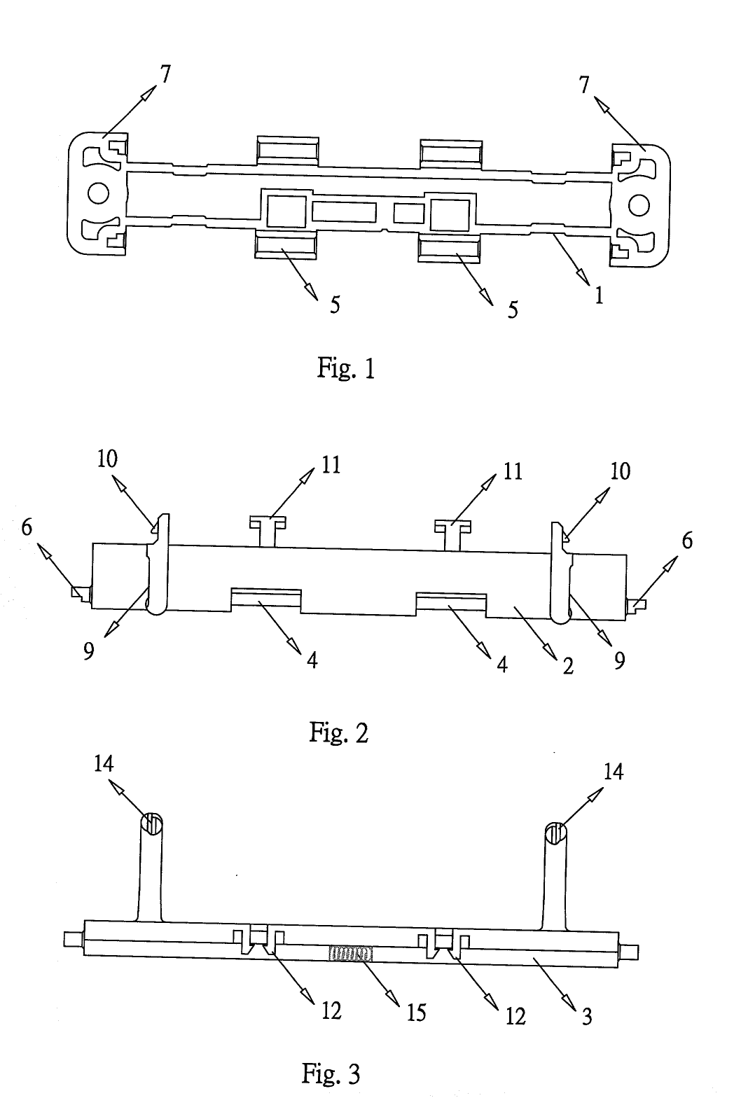

Please simultaneously review the three figures of the FIG. 1, FIG. 2 and FIG. 3 to understand what follows. This invention is mainly composed by a long type board fixture (1) a right hand buckle plate (2) and a left hand buckle plate (3) to form a frame of file folder apparatus. Meanwhile, the long type board fixture (1) and a right hand buckle plate (2) are connected by two close convex shoulder plate (4) and concave botch plate (5) together with two half-round convex flange (6) and two half-round concave (7). In the two right hand side buckle plate (2) there is affixed a 70% hook holder (8) to set up front and back sides of two concave flute (9). The 70% hook holder (8) has one point extruder convex fillet (10). There is a T type convex (11) on the flat side. In the long type board fixture (1) and left hand buckle plate (3), there is a combination of a left hand buckle plate (3) and two close convex shoulder plate (4) and two concave botch plate (5), together with two half-round convex flange (6) and two half-round concave (7). The horizontal plane part includes a inverse hook hanger and a 30% hook holder (13). The convex part includes a concave flute (14) and there is a spring (15) hanging on the back of it.

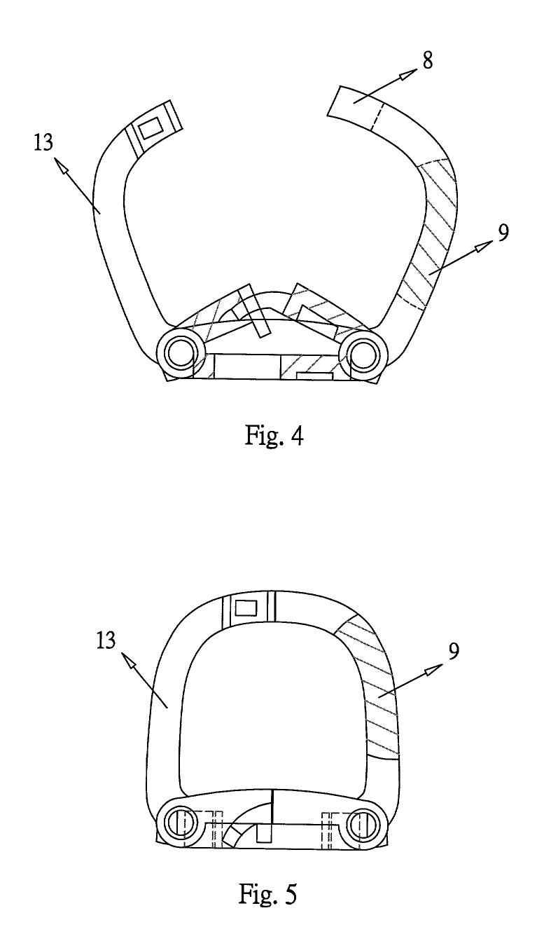

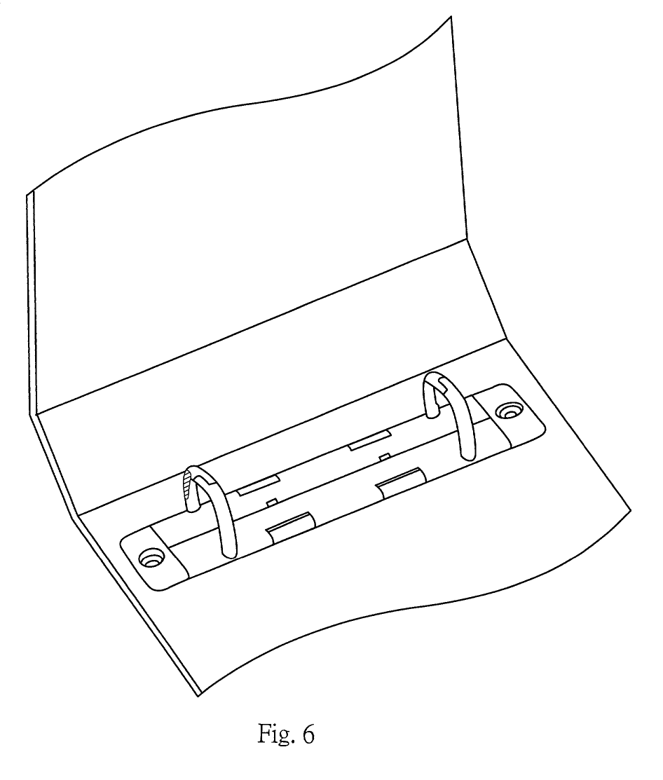

As FIG. 4 shows, when it is desired to open up the file folder, then press those back and forth's two concave flute (9) of the right hand buckle plate (2). Make sure the 70% hook holder (8) has a right hand buckle plate (2) that is one point extruder convex fillet (10) and a 30% hook holder (13)'s left hand buckle plate (3)'s concave flute are separated. Then use the left hand buckle plate (3)'s bottom spring (15)'s spring force. Let the left hand buckle plate (3) separated from the original one. And as the FIG. 5 shows, when it is to close up the file folder clip, just slightly press the 70% hook holder (8) and 30% hook holder (13)'s end point should do it.

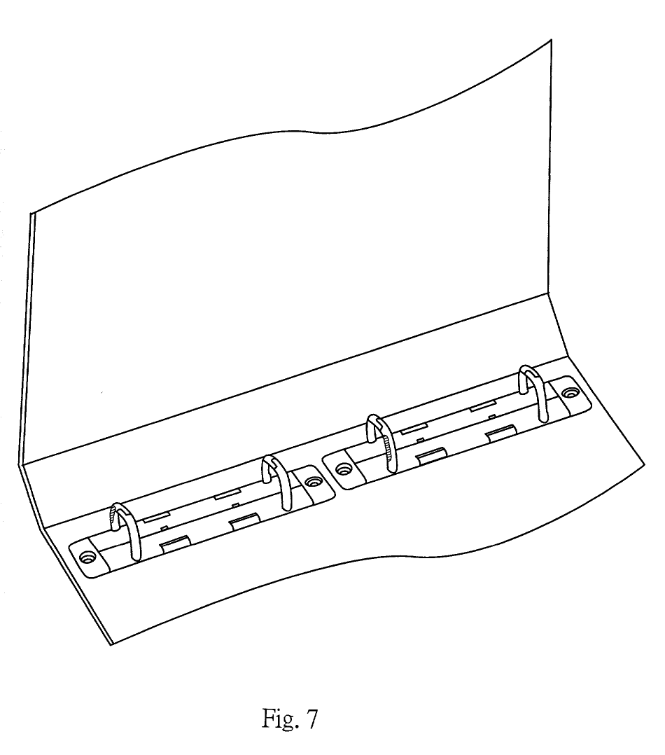

As the FIG. 6 shows, it is the file folder clip experimental one. Another one shows as it in FIG. 7, it's the two double holes file folder. But it has two opposite direction, with a total of four holes' real experimental one.

The other structure of the invention is to utilize all the same structure with the all the same thing and put them in the same file folder. But let the same file folder's long type board's up and down side, set another exactly the same thing but in the opposite direction. Let them show four holes file folder clip. And let paper document fold in the four holes file folder clip. Then the prevention of falling could occur.

In all, this invention utilize the spring function of the buckle plate. To match the press function of the concave flute to reach the one hand open file folder clip's function. It is to open up the clamp and collect the newspaper. By the simple and easy operation, it is to reach the set up of the documents and pick up of the paper documents. It is not only the practical use of the invention, but the totally new invention. The inventor has finished the sample for your reference. This is to present the application. Please examine the application as soon as possible. And please issue patent as you can.

1. A one hand open file folder clip structure is composed mainly by:
a long type board fixture; and
a right hand side buckle plate; and
a left hand side buckle plate; and
a spring; where
The long type board fixture and a right hand side buckle plate are connected by two coherently convex shoulder plate and concave notch plate. It is also connected by the two half round convex flanges and the two half round concave parts. On the two right hand side buckle plate there is a 70% hook holder which is set up by back and forth concave part to be pressed. Whereas, there is a point extruder convex fillet set up on the 70% hook holder. And on the plane part of the 70% hook holder there is a T type convex part. On the other part, the long type board fixture and left hand side buckle plate also were buckled up by coherently two convex shoulder and concave notch plate. While on the two left hand side buckle plate's 30% hook holder, there is a inverse hook hanger and 30% hook holder to have shank and concave flute. Whereas on the left hand side buckle plate's back place there is a spring.
When it is the time to open up the file folder clip, press the convex fillet of the right hand side buckle plates' back and forth two places. Make sure the 70% hook holder's of the right hand side buckle plate point extruder convex fillet and 30% hook holder's left hand side buckle plate are totally separated. Then utilize the left hand side buckle plate's spring force. It is to let the left hand side buckle plate to be separated. When it comes to close up the file folder clip, just slightly pressed down the end part of the 70% hook holder and the end part of the 30% hook holder.

2. As it is stated in the claim 1 of the one hand open file folder clip, this invention has its derivative. It is to use two of exactly the same file folder clip, and place them in the same document clip. Let the file folder clip's up or down side, put the same file folder clip but let it up side down. It is formed the four holes document folder in the same file. It is to prevent the document from falling down the wrong way.
